(19) United States
(12) Patent Application Publication
(10) Pub. No.: US 2018/0201513 A1
(43) Pub. Date: Jul. 19, 2018

(54) REDUCTION OF METAL/SEMI-METAL OXIDES

(71) Applicant: NORTHEASTERN UNIVERSITY, Liaoning Province (CN)

(72) Inventor: Ali Reza KAMALI, Dalian City, Liaoning Province (CN)

(21) Appl. No.: 15/741,714

(22) PCT Filed: Mar. 10, 2017
(86) PCT No.: PCT/CN2017/076254

§ 371 Date: Jan. 3, 2018

(30) Foreign Application Priority Data
Mar. 23, 2016 (GB) GB1604975.1

(51) Int. Cl. C01B 33/023; B22F 9/20; C01B 33/06; C01F 5/04

(52) U.S. Cl. CPC C01B 33/023; B22F 9/20; C01B 33/06; C01P 2004/64; B22F 2304/10; C01P 2004/61; C01F 5/04

(57) ABSTRACT

This invention is concerned with the reduction of metal and/or semi-metal oxides. More particularly the invention relates to a method and apparatus adapted to produce silicon by reduction of silicon oxides. The inventor has determined that the reaction between a strong oxidiser and a reducer can provide sufficient energy for metallothermic reduction of silicon oxides to silicon to be completed at relatively low temperatures, such as less than 580 deg C., and that the reduction can be effected with no or minimal dwell time even at such a maximum temperature. The method can be simple, quick, and efficient without producing greenhouse gases. This method can also be used for reduction of other metal or semi-metal oxides such as for example only Ta₂O₅, Nb₂O₅WO₃ and MoO₂; and also used in the co-reduction of two or more metal or semi-metal oxides to produce alloys and composites of them.

This invention is concerned with the reduction of metal and/or semi-metal oxides. More particularly the invention relates to a method and apparatus adapted to produce silicon by reduction of silicon oxides.

The inventor has determined that the reaction between a strong oxidiser and a reducer can provide sufficient energy for metallothermic reduction of silicon oxides to silicon to be completed at relatively low temperatures, such as less than 580 deg C., and that the reduction can be effected with no or minimal dwell time even at such a maximum temperature. The method can be simple, quick, and efficient without producing greenhouse gases. This method can also be used for reduction of other metal or semi-metal oxides such as for example only Ta₂O₅, Nb₂O₅WO₃ and MoO₂; and also used in the co-reduction of two or more metal or semi-metal oxides to produce alloys and composites of them.

Silicon is the eighth most abundant element in the universe, and the second most abundant in the earth's crust after oxygen. Silicon dioxide (silica) which is commercially used as a resource of silicon is very widely available. Elemental Silicon has a vast array of applications including deoxidising or alloying element for steel, in cast iron and aluminium alloys, raw material in the semiconductor industry (such as in electronic devices, photovoltaic cells, and biosensors), photonics and as a promising anode candidate within rechargeable lithium ion batteries.

The world production of silicon was about 7.7 million tonnes in 2014, from which about 80% was in the form of ferrosilicon with an average 77% silicon content. China was the largest producer of both ferrosilicon (about 6 million tonnes) and elemental silicon (about 1.3 million tonnes)[1].

Silicon is produced industrially in the form of either ferrosilicon or metallurgical-grade silicon. The latter is the precursor for preparation of polycrystalline or solar grade silicon used in the semiconductor and battery industry and also the precursor for preparation of silicon halides useful in the production of silicones.

Traditionally, elemental silicon is produced in an industrial scale by carbothermal reduction of silica in submerged-arc electric furnaces at temperatures of about 2000 deg C. [2]. At this temperature, molten silicon dioxide is reduced to molten silicon, but this process also generates CO₂ emissions (reaction 1).

SiO₂+C=Si(l)+CO₂(g) ΔG°=+103 kJ (at about 2000 deg C.) (reaction 1)

Moreover, carbothermic deoxidization of silicon oxide requires substantial energy (11 kWh/kg of Si), and adversely affects the environment through emission of carbon dioxide. The product of reaction 1 is bulk silicon with a purity of about 95-98% known as metallurgical-grade silicon; and is mainly produced in China, Russia, Brazil, Norway, South Africa, and USA. Metallurgical-grade silicon is typically ground into a powder form for further processing.

Considering the increasing world demand for silicon, and the need to comply with international agreements to reduce carbon emissions, the development of sustainable, green and simpler processes to obtain this element is highly desirable.

The main applications of silicon powder are as follows:

### Silicone

Polysiloxanes (or Silicones) are versatile polymers of silicon and oxygen with carbon and hydrogen, and can be synthesized to exhibit a wide variety of properties as fluids, elastomers or resins, for use in a wide variety of silicone compositions. Silicones can be used in diverse applications such as in implants, skin care products, artificial tears, burn treatments and other wound care, leather finishing, lubricating oils, adhesives, sealants, protective coatings for construction as well as in electrical and electronic products.

In industry, Silicones are produced by reacting pulverized metallurgical-grade silicon with methyl chloride in a fluidised bed to form chlorosilanes at 250 to 350 deg C. and at pressures of 1 to 5 bars; followed by polymerisation and polycondensation.

Global demand for silicones increased from 1.7 to 2.4 million tonnes between 2012 and 2018, representing average annual growth rate of nearly 6 percent. China is the largest producer of silicones and owns nearly 40 percent of global silicone-production capacity. Companies such as Dow Corning and Wacker Chemie are global leaders in silicone production.

### Polycrystalline Silicon

Photovoltaics (PV) is a fast growing market with an annual growth rate of PV installations of 44% between 2000 to 2014. Polycrystalline silicon, also called polysilicon or poly-Si, is a high purity, polycrystalline form of silicon used as raw material in the solar photovoltaic and electronics/semiconductor industry. Polycrystalline solar grade silicon is obtained by dissolving metallurgical grade silicon powder in hydrogen chloride generating a silane gas such as trichlorosilane; this is followed by the Siemens Process in which polycrystalline silicon is grown at very high temperatures.

### Lithium Ion Batteries

Lithium-ion batteries are widely used as a power source in portable electrical and electronic products. Graphite as a traditional anode material in lithium ion batteries (with a theoretical capacity of 372 mAh g⁻¹) cannot fulfil the requirements of automotive applications needing a high energy density; hence a new generation of high power batteries must be developed using advanced lithium storage materials as electrodes. According to the reactions between silicon and lithium, silicon can be electrochemically alloyed with lithium up to 4.4 atoms of lithium per one silicon atom to form Li₂₂Si₅ intermetallic phase. Therefore silicon is considered as the most promising anode material due to its high theoretical specific capacity of 4200 mAh g⁻¹. However, silicon shows severe volumetric changes up to 323% upon lithium insertion and extraction cycling, leading to microcracks or pulverization and therefore poor cyclability. Silicon containing nanocomposites are commonly used to overcome this problem.

### Silicon Nitride

Silicon nitride (Si₃N₄) is a ceramic with an excellent combination of properties including low density, very high fracture toughness, good flexural strength, and very good thermal shock resistance and operating temperature in an oxidizing atmosphere up to about 1300 deg C. These properties make silicon nitride ceramics appropriate candidates for applications as balls and rolling elements for light and extremely precise bearings, heavy-duty ceramic forming tools and automotive components subject to high stress. Si₃N₄ is prepared by heating powdered silicon between 1300 deg C. and 1400 deg C. in an atmosphere of nitrogen.

### Mg₂Si

Magnesium silicide (Mg₂Si) is used as an additive for some important aluminium alloys such as the 6xxx series. Mg₂Si is also a lightweight indirect gap narrow band semiconductor that can be used in a range of applications such as thermoelectric applications. The other applications of Mg₂Si include reinforcement for composites, anticorrosive coatings, interconnections in silicon planar technology, infrared optical devices, photovoltaic applications, as an alternative for anode materials in rechargeable lithium batteries, and in hydrogen storage.

Direct Production of Si Powder from SiO₂

The smelting carbothermic reduction of SiO₂ leads to the production of molten silicon. Silicon powder might be produced directly from SiO₂ by solid state metallothermic reduction methods. Below is a summary of methods developed for solid state reduction of SiO₂.

### Aluminothermic Reduction

The reaction of SiO₂ with molten aluminium can lead to the formation of silicon and alumina, according to the following reaction [3]:

4Al+3SiO₂→2Al₂O₃+3Si (reaction 2)

However, preparation of Si by this reaction is hindered by its dissolution in the molten aluminium and by formation of an alumina layer which suppresses progression of the reduction process. This process has been adapted for the preparation of alumina reinforced Al—Si composites [4].

### Electrochemical Reduction

Electrochemical deoxidation of SiO₂ in molten salt electrolytes was discussed by Nohira et al. [5] and Jin et al. [6]. However, bulk electrodeoxidation of SiO₂ is difficult, considering the fact that SiO₂ is an insulator.

### Magnesiothermic Reduction

Magnesiothermic reduction of SiO₂ is the most promising alternative method for producing Si (reaction 3) from SiO₂ [7-15]. Silica can also be used to prepare Mg₂Si—MgO (reaction 4), which can be subsequently used in the production of some composites.

2Mg(g)+SiO₂=Si+2MgO ΔG°=−333 kJ (at 700 deg C.) (reaction 3)

4Mg(g)+SiO₂=Mg₂Si+2MgO ΔG°=−477 kJ (at 700 deg C.) (reaction 4)

The intermetallic compound Mg₂Si is an interesting material with a wide range of possible applications such as use as the strengthening phase in metal matrix composites [16], use as a hydrogen storage medium for renewable energy systems [17], use as anode materials for lithium ion batteries [18] and within certain thermoelectric applications [19].

The magnesiothermic reduction of SiO₂, however, takes place at relatively high temperatures above 650 deg C. requiring a dwell time at maximum temperature of 2-5 h [7-15]. In fact, this process in which magnesium vapour acts as the reducing agent suffers from poor scalability. Even a very low concentration of oxygen in the reaction atmosphere is sufficient to oxidise magnesium vapour over long process times, therefore special equipment must be used. Hence, simultaneously lowering the temperature of the reaction between SiO₂ and Mg whilst reducing the reaction time would significantly increase scalability of the reduction process, being desirable conditions not yet achieved together.

There have been reported attempts towards lowering the reaction temperature of the metallothermic reduction of SiO₂. Xing et al. [19] reported that solid silicon monoxide, SiO, which is less stable than SiO₂, can be converted into Si when heated with Mg at 500 deg C. for 1-12 h. At such a modest temperature, the reaction could be conducted with a solid mixture of SiO and Mg powders in a flowing H₂—Ar mixture within a tube furnace without appreciable magnesium vapour loss [19].

Ning Lin et al. [20] produced Si by reacting SiO₂ with AlCl₃ and either aluminium or magnesium at temperatures of 200-250 deg C., according to the following reactions:

4Al+3SiO₂+2AlCl₃→3Si+6AlOCl (reaction 5)

2Mg+SiO₂+6AlCl₃→2MgAl₂Cl₈+2AlOCl+Si (reaction 6)

This process, however, required a stainless steel autoclave packed in a N₂ glove box, as AlCl₃ is very sensitive to moisture. Moreover, the process was performed in a 20 mL autoclave using only about 1 g SiO₂ but for which 8 g AlCl₃ was required. Although the reaction temperature was found to be 250 deg C., the reaction was prolonged and required 10 h to reach only 75 percent completion.

Other major problems of the available metallothermic reduction methods used to obtain Si relate to the incompleteness of the process. Formation of a layer of silicon on the surface of SiO₂ hinders progress of the reduction process, and hence, the core of silica particles may not be converted to Si.

### Demagnesiation of Mg₂Si to Si

Above 500 deg C., Mg₂Si reacts with O₂ in air to yield MgO and Si, according to the following reaction [21].

Mg₂Si+O₂→Si+2MgO (reaction 7)

However, this process is time consuming, and also the resulting Si product itself can be oxidized. For example, Si was produced by air-oxidation of Mg₂Si at 600 deg C. for 10 hours [22].

Reaction of Mg₂Si with Acids

It is known that Mg₂Si dissolves in dilute acids to evolve monosilane [23]:

Mg₂Si+2H₂SO₄=2MgSO₄+SiH₄(g) ΔG° (at 25 deg C.)=−783 kJ (reaction 8)

### Invention Description

The current invention has two aspects:

In a first aspect, the present invention concerns a process for the production of Si and/or Mg₂Si from SiO₂ in which the reaction temperature is below 580 deg C. and there is virtually no need for a dwell time. For example the reaction temperature can be from 350 deg C. to less than 580 deg C., preferably 360 deg C. to 570 deg C., even more preferably 370 deg C. to 530 deg C.

According to this first aspect of the invention there is provided a method of reducing one or more single or mixed oxides of metal and/or semi-metal other than titanium, which involves use of an initial reaction at a temperature of less than 580 deg C. between a strong oxidising agent or metal halide with a reducing agent to effect reduction of said oxide(s).

This aspect of invention embraces very effective methods for the preparation of Si (for example but without limitation in reaction 9) and Mg₂Si (for example but without limitation in reaction 10) from SiO₂—containing raw materials, which can take place at a relatively low temperature of 350-580 deg C., the actual reaction temperature being dependent on the SiO₂ particle size, with virtually no dwell time, whereby the reaction can be completed immediately or within seconds, at the reaction temperature.

(4+4/x)Mg+2SiO₂+1/xKClO₄=(4+4/x)MgO+1/xKCl+2Si ΔG°=−[2353/x+542] kJ (at 350 deg C.) (reaction 9)

(4+4/x)Mg+1/xKClO₄+SiO₂=(2+4/x)MgO+1/xKCl+Mg₂Si ΔG°=−[2353/x+344] kJ (at 350 deg C.) (reaction 10)

The temperature of the reduction process can be controlled by the particle size of the metal/semi-metal oxide.

These processing conditions (low temperature of 350-580 deg C. and no, or practically no, dwell time) provide an opportunity for large-scale production of Si using SiO₂ and Mg. No vacuum condition, autoclave, or prolonged treatment is required, although in some embodiments a vacuum can be deployed.

Conventionally, when SiO₂ reacts with Mg, a layer of Si forms on the SiO₂ particles, and therefore in conventional such methods, the core of SiO₂ particles cannot be reduced to Si. The reduction process here described and claimed however can be carried through to completion in a remarkably short timescale which means that unlike conventional reactions, the core of SiO₂ particles can also be reduced to Si and/or Mg₂Si as well as their surface.

Other reducing agents, such as, for example only, Ca and Na and other oxidising agents can potentially be employed.

### Possible Alternatives for KClO₄

Preferred oxidising agents include metal perchlorate salts such as potassium perchlorate (KClO₄), magnesium perchlorate (Mg(ClO₄)₂), sodium perchlorate (NaClO₄), calcium perchlorate (Ca(ClO₄)₂) and iron perchlorate (Fe(ClO₄)₂). The oxidising agent may alternatively be a metal chromate such as barium chromate (BaCrO₄) and lead chromate (PbCrO₄). The oxidising agent may be a metal oxalate such as magnesium oxalate (MgC₂O₄), iron oxalate (FeC₂O₄), copper oxalate (CuC₂O₄). Oxidising agent may be a metal chlorate such as potassium chlorate (KClO₃), sodium chlorate (NaClO₃) and magnesium chlorate, Mg(ClO₃)₂. Oxidising agent may be ammonium dinitramide, ammonium perchlorate or chlorite.

Oxidising agent also may be a metal oxide which is energetically less stable than the oxide form of the reducing agent. Reaction of these oxidiser/reducing agents provides energy to promote the metallothermic reduction of SiO₂ at usefully much lower temperature and dwelling time. Therefore oxidiser agent may be a metal oxide such as Fe₂O₃, Pb₂O₃, SnO₂, AgO, Cu₂O and NiO. Reaction of such metals oxides with strong reducing agents such as Mg and Ca may provide sufficient energy, more than the activation energy needed for the reduction of SiO₂.

Metal halides include fluoride, chloride, bromide, and iodide. Instead of oxidising agents, we may use a halide agent. A halogeniser agent is a metal halide. In this case, the stability of the halide should be much less than that of the halogen form of the reducing agent used (Mg, Ca, Al etc), so that their reaction can provide sufficient energy to initiate the metallothermic reduction of SiO₂. Therefore the halogeniser can be, for example only, FeCl₃. In this case the general reaction is:

SiO₂/Mg/FeCl₃→Si(Fe)/MgCl₂/MgO (Reaction 10a)

Si(Fe) represents an alloy of Si and Fe.

The invention also provides in a second aspect a process for the conversion of Mg₂Si to Si by acid leaching of Mg₂Si for instance: For example only and without limitation:

Leaching of this silicide compound in sulphuric or nitric acids according to the following reations;

Mg₂Si+2H₂SO₄=2MgSO₄+2H₂(g)+Si ΔG° (at 25 deg C.)=−840 kJ (reaction 11)

Mg₂Si+4HNO₃=2Mg(NO₃)₂+2H₂(g)+Si ΔG° (at 25 deg C.)=−780 kJ (reaction 12)

It should be noted that in relation to this acid leaching in general and reactions 11 and 12 above, the acid dissolves magnesium oxide/hydroxide MgO (Mg(OH)₂) formed in the reaction as per reactions 9 and 10 above.

In order that the invention may be illustrated, more easily appreciated and readily carried into effect by those skilled in the art, embodiments of the invention will now be described purely by way of non-limiting example with reference to the accompanying drawings, graphs and photomicrographs, wherein:

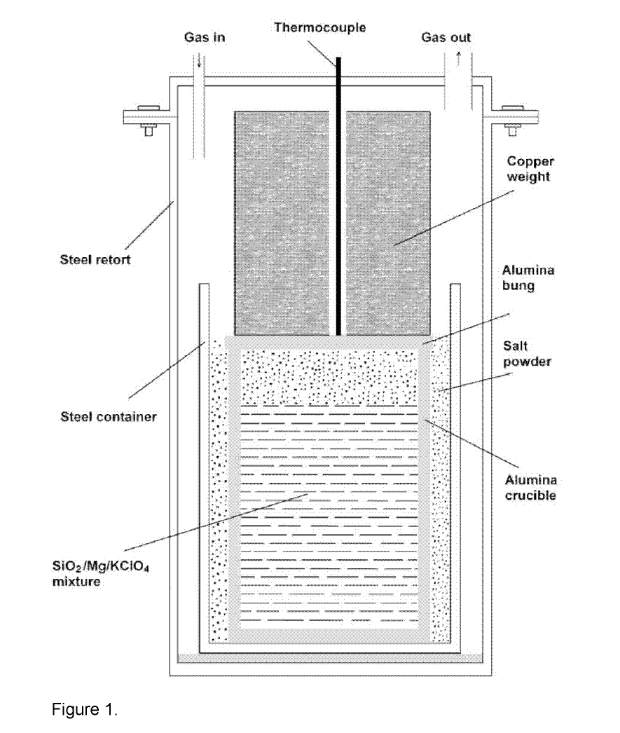

FIG. 1 is a cross-sectional view through a reactor apparatus suitable for the reduction of silica to Si,

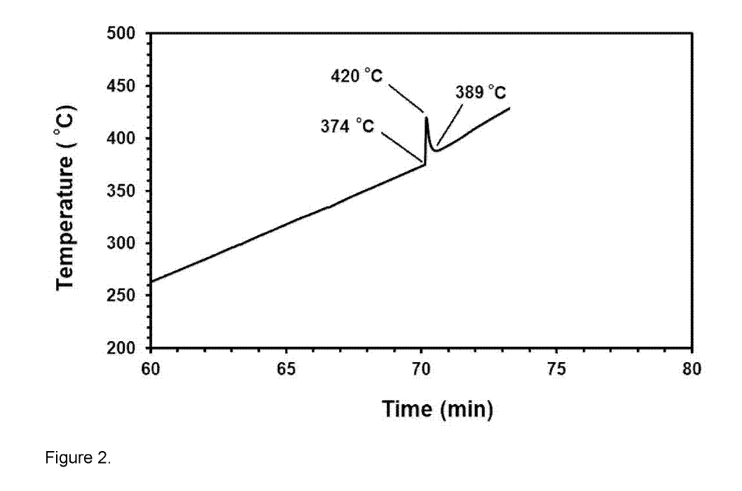

FIG. 2 is a selected region of temperature-time plot curve recorded during heating the mixture of SiO₂ nanoparticles, Mg chips, and KClO₄, in which the ignition temperature of the mixture can be identified from this curve to be 374 deg C.,

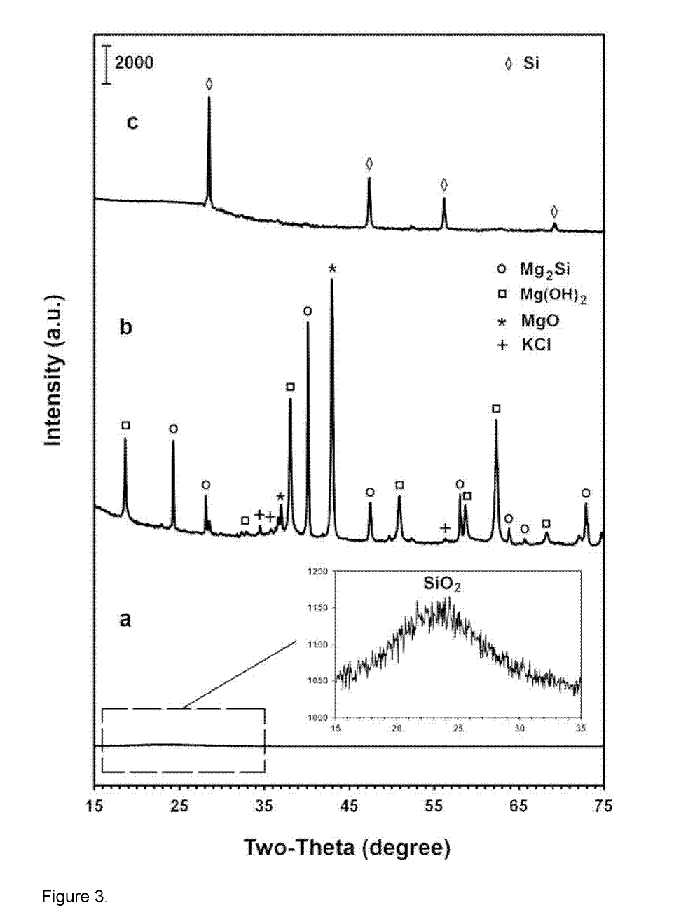

FIG. 3 is the X-ray diffraction pattern of (a) SiO₂ nanoparticles used as the Si source, (b) the as-synthesised product obtained by heating of SiO₂ and Mg in the presence of a small amount of KClO₄ and (c) the product obtained by washing of the as-synthesised product in HNO₃,

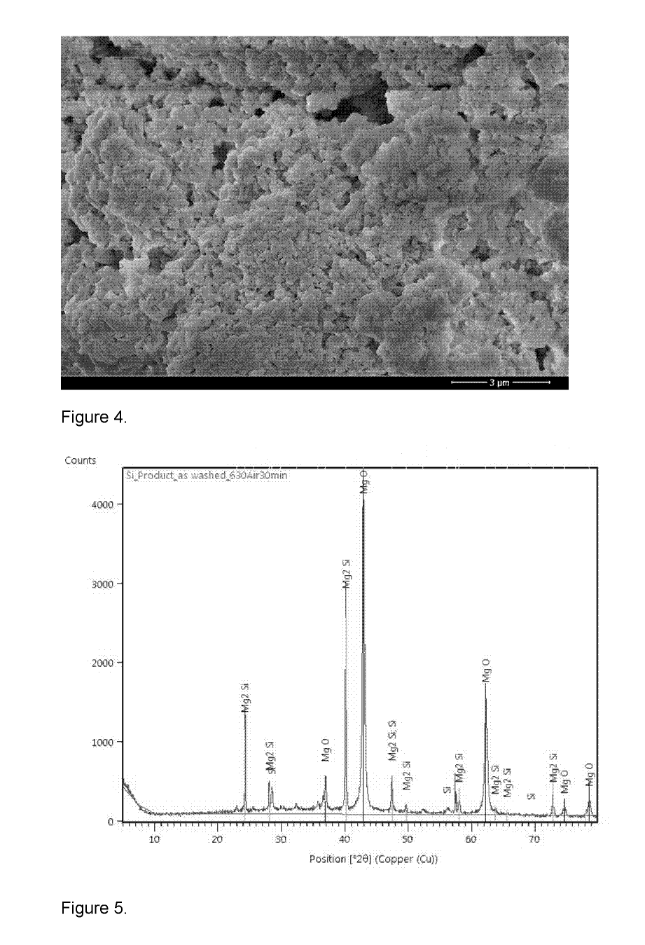

FIG. 4 is a secondary electron micrograph of the as-synthesised product produced from SiO₂ nanoparticles comprising of mainly Mg₂Si and MgO,

FIG. 5 is an XRD result of the as-synthesised product produced using SiO₂ nanoparticles after heating to 630 deg C. in air,

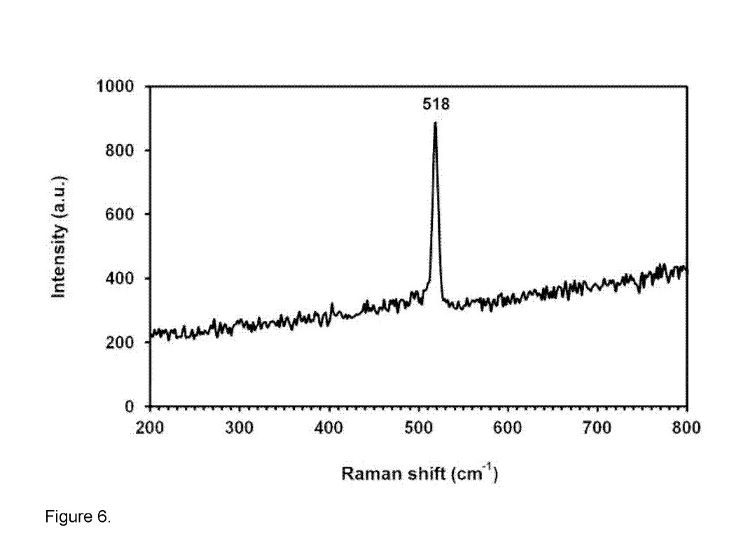

FIG. 6 is a Raman spectra of the silicon produced using SiO₂ nanoparticles,

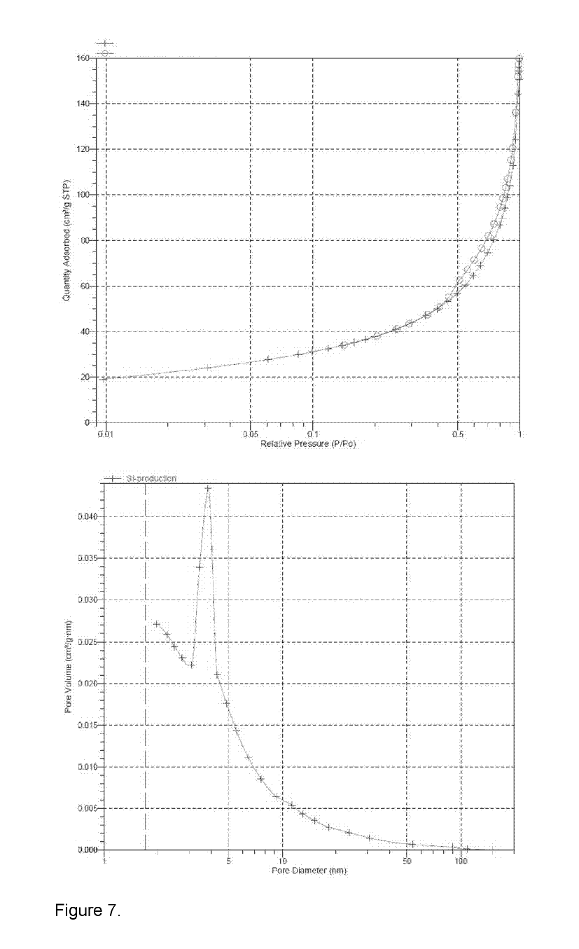

FIG. 7 (a) is the adsorption-desorption nitrogen isotherm and (b) the dependency of differential volume on pore size of the Si product produced using SiO₂ nanoparticles,

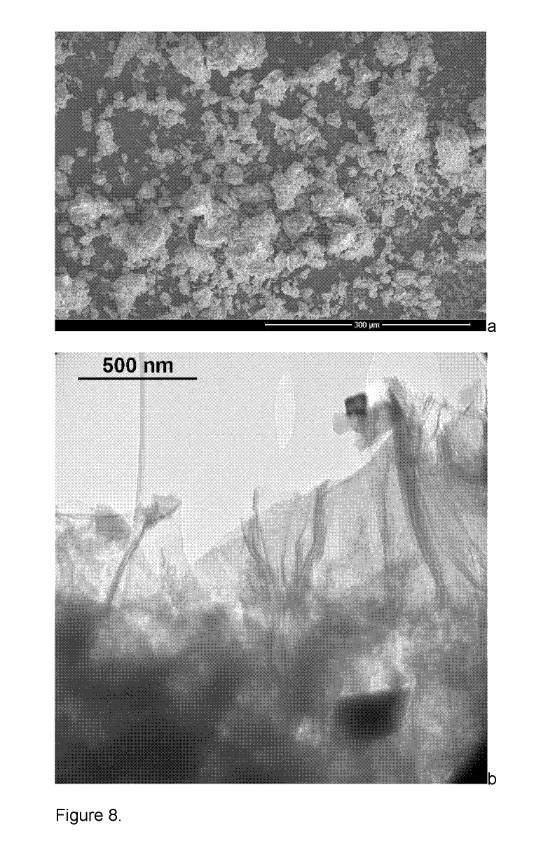

FIG. 8 (a) is a SEM and (b) is a TEM micrograph of the Si powder produced using SiO₂ nanoparticles,

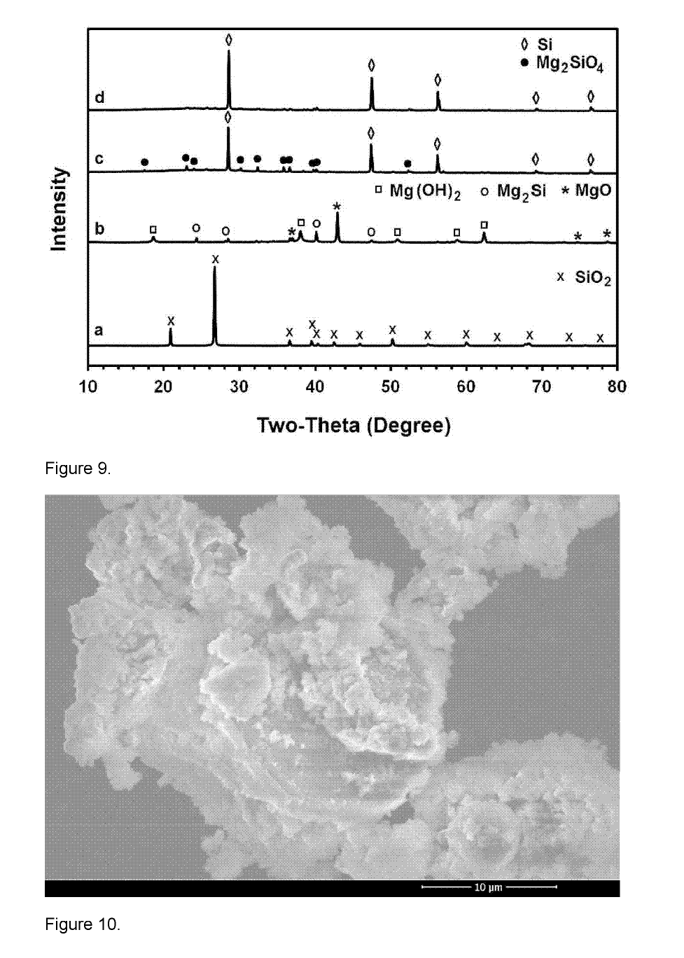

FIG. 9 is an X-ray diffraction pattern of (a) 1-5 micrometer-sized SiO₂ particles, (b) the product obtained after the reduction process and water washing, (c) the product obtained by washing of (b) in H₂SO₄ (95%) in an ice bath, and (d) the product obtained by washing of (b) in HNO₃ (70%) in an ice bath,

FIG. 10 is an SEM micrograph of the product produced using micrometer-sized SiO₂ particles consisting of Mg₂Si and MgO,

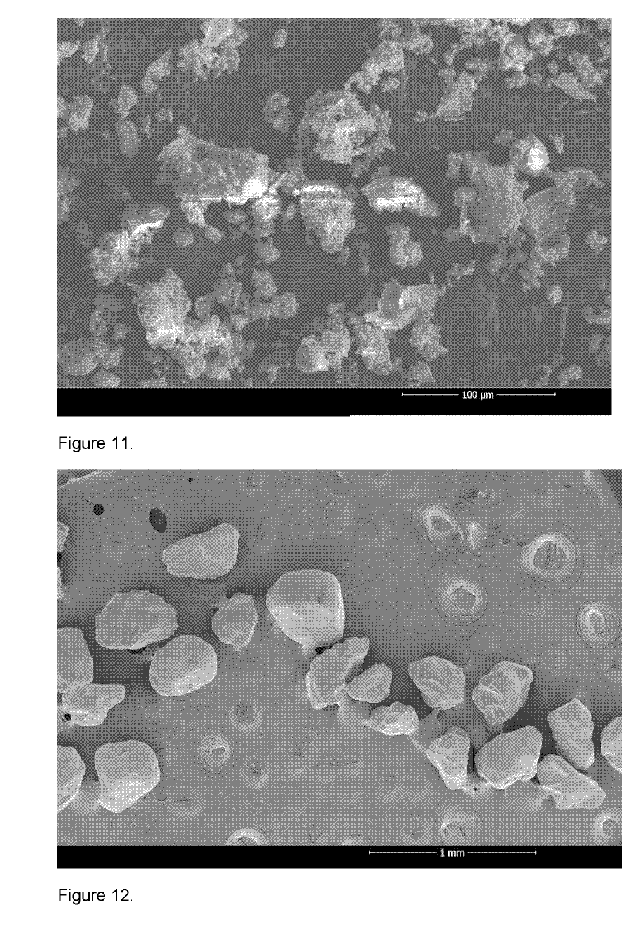

FIG. 11 is an SEM micrograph of silicon powder produced using micrometer-sized SiO₂ particles,

FIG. 12 is an SEM micrograph of sand collected from the beach of Winterton-On-Sea, a village in the English county of Norfolk,

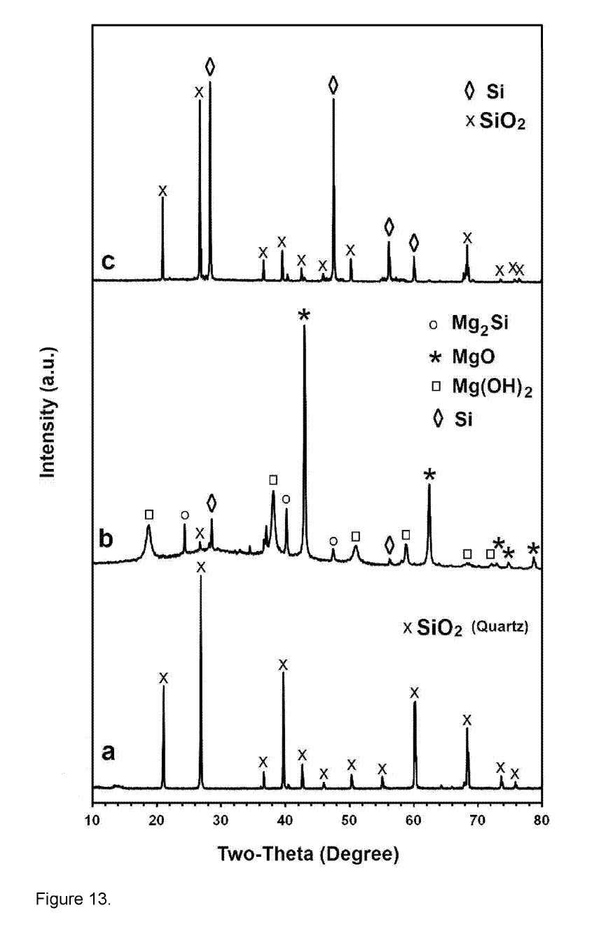

FIG. 13 is an X-ray diffraction pattern of (a) sand collected from a beach of English county of Norfolk after washing with distilled water and drying, (b) product obtained after the reaction with Mg and KClO₄ and (c) the product obtained after acid washing,

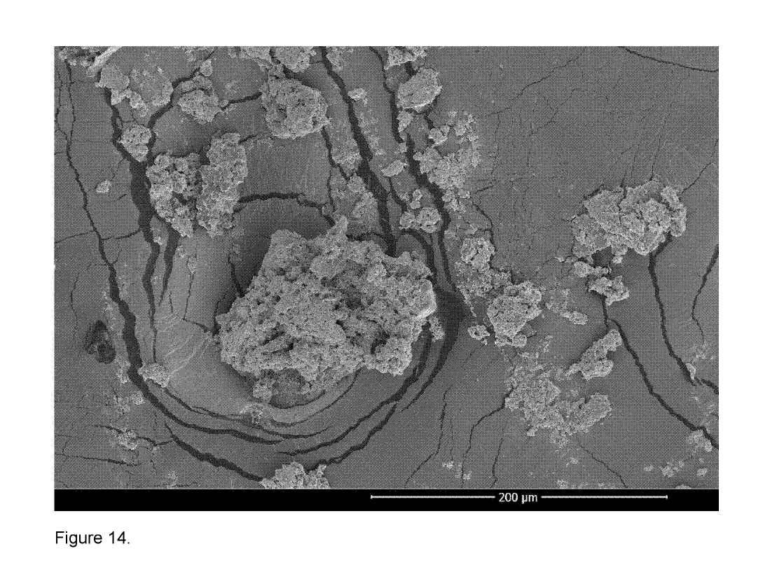

FIG. 14 is an SEM morphology of the beach sand ball milled for 72 h,

FIG. 15 is an XRD pattern of (a) the beach sand, (b) the beach sand after 72 h ball milling, and (c) the 72 h milled sample reacted with Mg and KClO₄ followed by acid washing, filtration and drying,

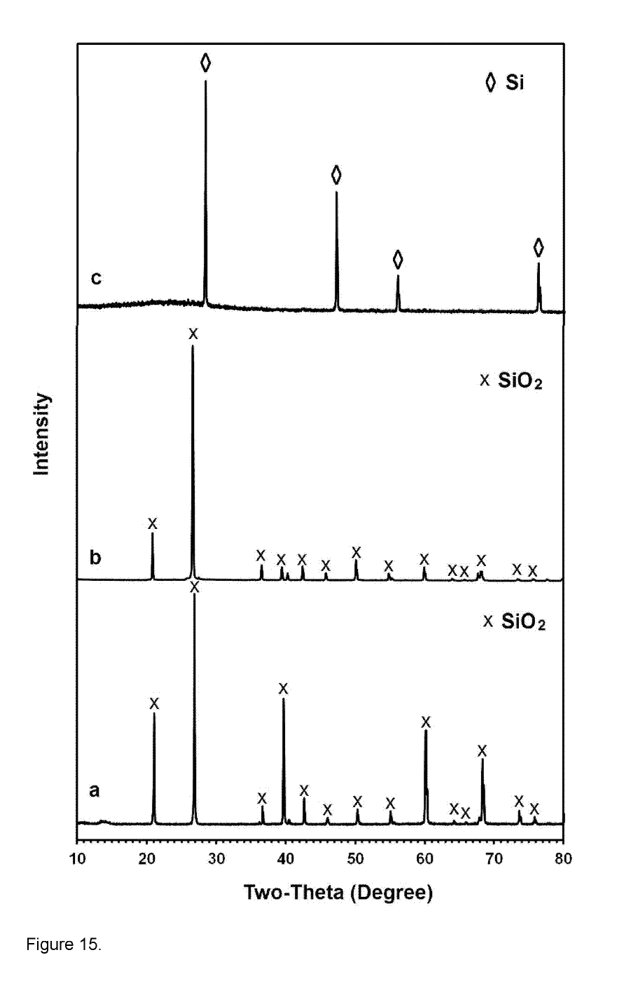

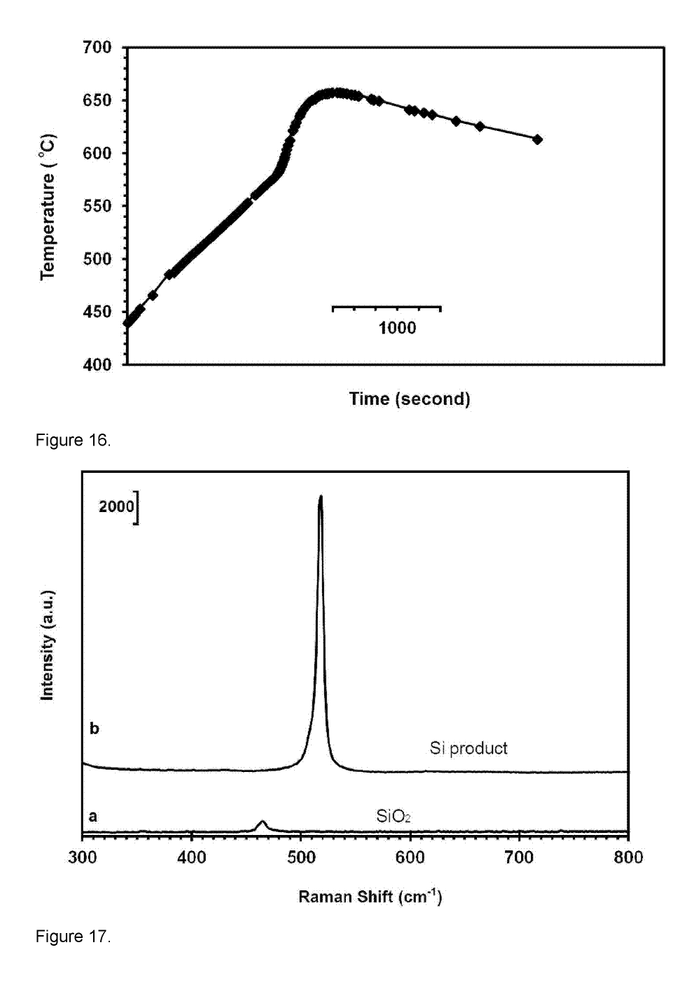

FIG. 16 is a temperature-time profile during heating a mixture of ball-milled sand, Mg and KClO₄, wherein the reaction takes place at about 577 deg C., demonstrated by an increase of the curve slope,

FIG. 17 is the Raman spectrum of (a) as-collected sand and (b) Si product,

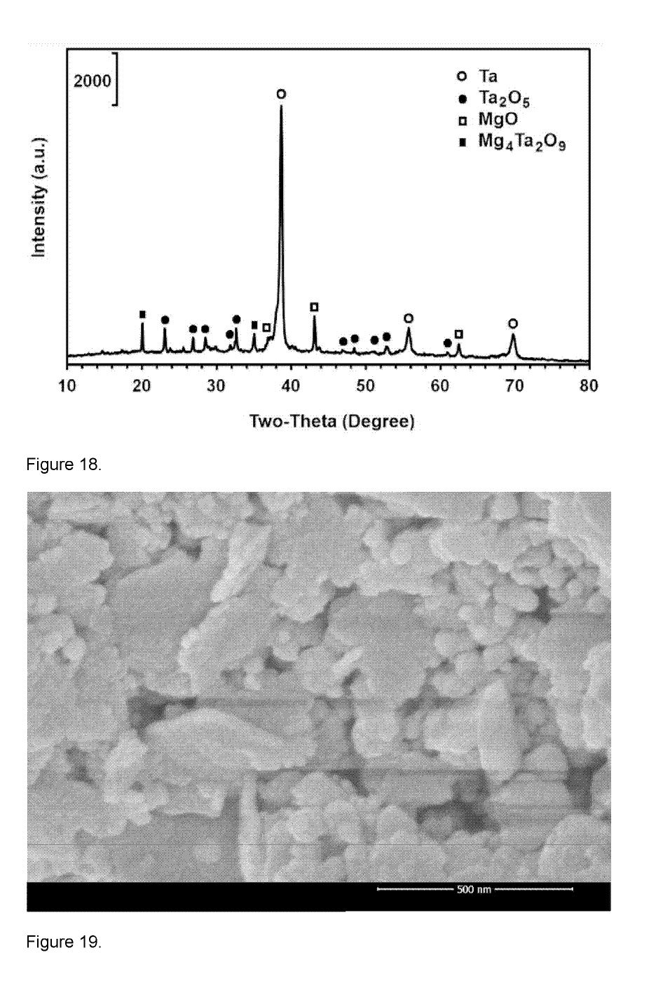

FIG. 18 is the XRD pattern of the product obtained in Example 5 by heating of Ta₂O₅, Mg and KClO₄ followed by washing, filtering and drying steps, and

FIG. 19 is an SEM micrograph of the product obtained in Example 5 by heating of Ta₂O₅, Mg and KClO₄ followed by washing, filtering and drying steps.

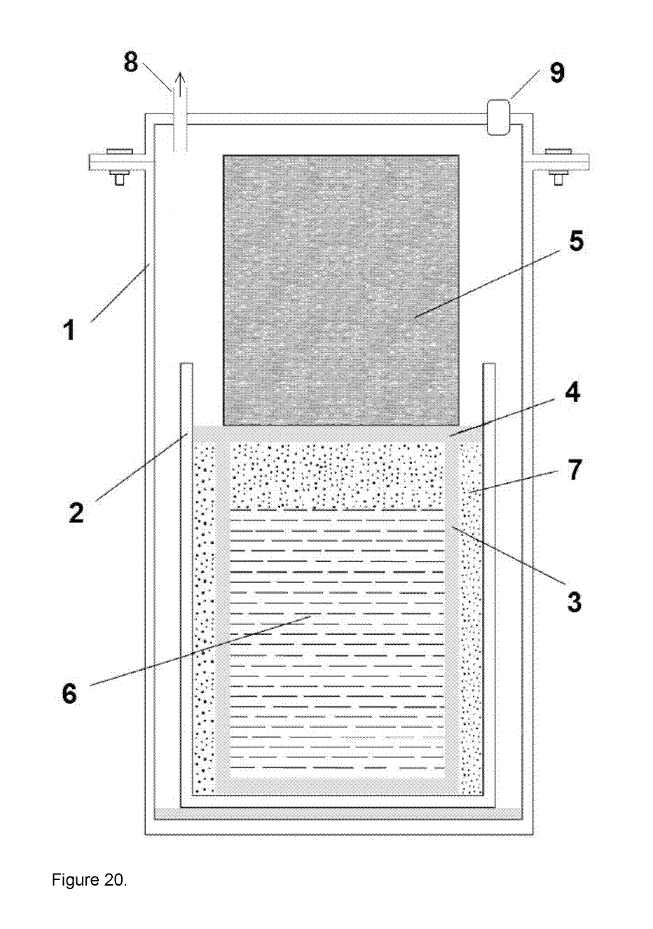

FIG. 20 shows a cross-sectional view through a preferred reactor apparatus suitable for the reduction of silica to Si.

Referring to the drawings, graphs and photomicrographs, the reactor used for the reduction of SiO₂ is shown in FIG. 1. In a typical experiment, SiO₂, Mg chips and KClO₄ powders are mixed and the mixture is placed in an alumina crucible. The powder mixture was further pounded by means of a mallet. The extra space left in the alumina crucible above the reaction mixture is filled with NaCl salt. The crucible is then closed by means of a ceramic bung, and placed in a steel container. The gap between the alumina crucible and the steel container until the bung level is also filled with NaCl. Then a cylindrical copper weight is placed on the ceramic bung. The copper cylinder had a vertical open hole in the middle so that a thermocouple could be passed through the copper weight to be in contact with the alumina bung.

The presence of a reaction dampener, such as an inert salt, for example NaCl powder above the reaction mixture and between the crucible and steel container is desirable to damp the shock generated by the reactions in the alumina crucible. It also further protects the reactive mixture and the products from the environment. It is easy to remove, (e.g. by simple aqueous washing) after the reaction has completed without deleterious effect upon the recovered silicon or silicide.

The steel container is placed in a retort furnace equipped with gas inlet and outlet. An argon flow is passed through the steel retort as the retort was heated in a resistance pot furnace, and the temperature was recorded by a thermocouple.

### EXAMPLE 1

1.1 Low Temperature Conversion of SiO₂ to Mg₂Si

37 g SiO₂ nanoparticles (Sigma Aldrich 637238, 10-20 nm), 51 g Mg chips (Sigma Aldrich 254118, 4-30 mesh), and 4.5 g KClO₄ powder (Sigma Aldrich 241830) was mixed and loaded into the reactor shown in FIG. 1. The reactor was placed in a resistance pot furnace and heated up. FIG. 2 shows the temperature profile recorded. From FIG. 2, the ignition temperature of the reaction can be found to be 374 deg C. This temperature is the lowest temperature recorded so far for the magnesiothermic reduction of SiO₂.

After completion of the reaction, the furnace was turned off and the reactor was left to cool to room temperature. Then, the alumina crucible was removed from the retort and its content was washed with distilled water to remove NaCl and then vacuum filtered. The material obtained (which is called the as-synthesised product) was subjected to x-ray diffraction analysis (XRD). FIG. 3 shows the result. FIG. 3a exhibits the XRD pattern of the SiO₂ raw material. The low-dimensional feature of the SiO₂ crystallite is evident from the weak broad diffraction peak shown in the figure. The XRD pattern of the as-synthesised product (FIG. 3b) shows the presence of Mg₂Si, Mg(OH)₂, MgO and KCl. Additionally, a small peak at two-theta=28.4876 degrees could also be detected in the diffraction pattern, which can be assigned to (111) diffraction peak of elemental Si. It should be mentioned that the amount of Si produced in the product can easily be increased by simply reducing the relative amount of Mg used in the preparation process. No diffraction peak related to SiO₂ could be detected, demonstrating the completion of reaction 10. Immediate conversion of SiO₂ and Mg into Mg₂Si (Si) and MgO (Mg (OH)₂) at 370 deg C. represents a highly desirable objective. An SEM micrograph of the as-synthesised product is shown in FIG. 4.

It should be noted that heating of the as-synthesised product to 630 deg C. in air leads to the formation of Mg₂Si and MgO composite powder which is useful in its own right. FIG. 5 shows the XRD diffraction pattern of the composite powder produced.

### 1.2. Conversion of Mg₂Si to Si

Ten gram of the as-synthesised material was gradually added to 100 mL HNO₃ (70%) at 50 deg C. while the solution was stirred by a magnet, which led to the release of gas. After 1 h stirring, the solution was diluted by distilled water and vacuum filtered, and then further washed with distilled water. The filtrate (3.8 g) was dried at 50 deg C. overnight. The final product which was 1.8 g light yellowish powder was subjected to XRD analysis, and the result is presented in FIG. 3c, demonstrating that the final product is Si.

The Raman spectrum of the silicon product taken using 633 nm laser excitation wavelength is shown in FIG. 6. The band with the maximum at 518 cm⁻¹ is attributed to crystalline silicon. In should be noticed that the maximum of the Raman line is about 521 cm⁻¹ in bulk crystalline silicon. The shift of the Raman Si peak in the direction of smaller wave numbers (such as 518 cm⁻¹) is characteristic for nanoscrystalline silicon structures; brought about by the effect of spatial confinement of optical phonons [24].

The surface properties of the silicon product was studied through the nitrogen adsorption-desorption technique. FIG. 7a shows the isotherms obtained. According to the IUPAC classification [25], this curve displays a type-IV isotherm and a type-H₄ hysteresis loop. This is indicative of multilayer adsorption onto surfaces and capillary condensation within mesopores. FIG. 7b shows the dependency of differential volume on pore size for the desorption branches of the isotherm. According to the Barrett-Joyner-Halenda (BJH) model [26], these curves are representative of pore size distribution. It can be concluded that the silicon product exhibits uniform mesoporosity, with the peaks of pore size distribution at 3.7 nm. The BET Surface Area of the silicon product was measured to be 137 m² g⁻¹.

SEM and bright field TEM micrograph of the Si powder produced is shown in FIG. 8. As seen, the Si powder has agglomerate sizes of less than 100 μm and contains a high fraction of nanostructures such as nanosheets.

### EXAMPLE 2

12.82 g SiO₂ (Sigma Aldrich, 0.5-10 μm, 80% 1-5 μm), 16.44 g Mg chips (Sigma Aldrich 254118, 4-30 mesh) and 3.01 g KClO₄ powder (Sigma Aldrich 241830) was mixed and the mixture was placed in an alumina crucible.

The mixture was heated to 530 deg C., and then the reactor was allowed to cool down. Then, the material inside the crucible was aqueously leached with distilled water, to remove NaCl which might be mixed with the product, and filtered. The XRD result of the material obtained is shown in FIG. 9b indicating the presence of Mg₂Si,MgO and Mg(OH)₂. No SiO₂ peak could be identified in the XRD pattern demonstrating the complete reduction of SiO₂ particles. SEM morphology of this material is shown in FIG. 10. As seen, the material consists of a dense agglomeration of fine particles. This morphology suggests that the composite powder can be directly used for making Mg₂Si—MgO composites.

The filtrate was dried at 30 deg C., and washed with H₂SO₄ (95%) and HNO₃ (70%). For acid washing, first 250 ml of H₂SO₄ acid was transferred in a 1 L beaker and that beaker was placed in a 2 L beaker. Then, the empty space between the two beakers was filled with ice. The acid was stirred by an application of a magnet stirring system and the as-synthesised product containing Mg₂Si and MgO was gradually added to the acid. This addition of the Mg₂Si—MgO mixture to the acid solution causes small sparks. The application of an ice bath leads to the control of the temperature and thus minimises any oxidation of silicon produced. FIG. 9 shows the XRD diffraction pattern of the SiO₂ raw material and the products obtained after each stage. The final product is Si which may contain a small amount of other phases such as SiO₂ and Mg₂SiO₄. These phases can be easily removed by dissolving in HF, from which pure silicon can be obtained.

FIG. 11 shows an SEM micrograph of the final product, demonstrating the formation of Si powder with particles and agglomerates less than 100 μm. Most of the agglomerates have a fine morphology containing silicon nanoparticles and nanosheets.

### EXAMPLE 3

A sample of sand was collected from the beach of Winterton-On-Sea (a village in the English county of Norfolk). FIG. 12 exhibits an SEM micrograph of the powder showing the SiO₂ particles have sizes from 200 to about 600 μm. XRD analysis was performed on the as collected sample, and the result is shown in FIG. 13a, demonstrating the beach sand collected is pure quartz SiO₂.

37 g sand of the same sample was dried at 100° C. and mixed with 51 g Mg chips (Sigma Aldrich 254118, 4-30 mesh) and 4.0 g KClO₄ powder (Sigma Aldrich 241830). The mixture was placed in an alumina crucible and the powder mixture was further pounded by means of a mallet. The extra space left in the alumina crucible above the reaction mixture was filled with NaCl salt. The crucible was then sealed by means of a ceramic bung, and placed in a second alumina crucible and the gap between the two alumina crucibles until the bung level was filled with additional NaCl. Then a cylindrical copper weight was placed on the ceramic bung.

The alumina crucible was placed in a retort furnace equipped with gas inlet and outlet. An argon flow was passed through the steel retort as the retort was heated in a resistance pot furnace to 570 deg C. The retort was then left to cool down to room temperature, the alumina crucible was removed from the retort and its content was washed with distilled water to remove NaCl and then vacuum filtered. The material obtained was dried under vacuum at room temperature for 1 h. The dried material (which is called the as-synthesised product) was subjected to XRD analysis, and the result can be seen in FIG. 13b. The product consisted of Mg₂Si, MgO, Mg (OH)₂, Si and of SiO₂.

5 g of the material obtained was washed with 100 mL H₂SO₄ with a concentration of 91% in an ice cooled container for 1 h. Then, the acid was diluted by adding distilled water to 20% H₂SO₄ causing an increase in temperature to 80 deg C. The solid material (with a yellow-dark brown colour) was subsequently washed with HNO₃ with concentration of 67% at 50 deg C. Then, the solid material was filtered and the filtrate was dried under vacuum. The XRD result of the product is shown in the FIG. 13c. The product consists of Si and SiO₂.

### EXAMPLE 4

A sample of sand from the same origin as Example 3 was ball milled for 72 h by a low energy rotating ball milling device using a plastic container and alumina balls with the ball:sand ratio of 10:1. The SEM morphology of the milled powder is shown in FIG. 14. This figure shows the sand particle sizes reduced to mainly less than 100 μm. Moreover it is clear that each particle in the milled sand is in fact an agglomeration of much smaller particles. The XRD result of the ball milled sand is shown in FIG. 15b. The XRD pattern of the as collected SiO₂ is also shown for comparison. It is seen that the ball milled sand consists of pure SiO₂ in quartz structure.

37 g ball milled sample was dried at 100° C. and mixed with 51 g Mg chips (Sigma Aldrich 254118, 4-30 mesh) and 4.1 g KClO₄ powder (Sigma Aldrich 241830). The mixture was placed in an alumina crucible and the powder mixture was further pounded by means of a mallet. The extra space left in the alumina crucible above the reaction mixture was filled with NaCl salt. The crucible was then capped by means of a ceramic bung. The crucible was placed in a second alumina crucible and the gap between the two alumina crucibles up to the bung level was filled with additional NaCl. Then a cylindrical copper weight (about 1 kg) was placed on the ceramic bung.

The alumina crucible was placed in a steel retort equipped with gas inlet and outlet, and an argon gas flow was maintained through the retort, whilst it was heated in a resistance pot furnace with a heating rate of about 6° C. min⁻¹. The temperature was continuously recorded by the thermocouple attached to the ceramic bung. The temperature-time profile of the run is shown in FIG. 16. As seen the reaction takes place at 577° C., leading to an increase of temperature (measured by the thermocouple attached to the alumina cap) by a rate of about 100° C. min⁻¹. Then, the furnace was turned off and the retort left to cool down to room temperature. The reaction product materials obtained were washed with distilled water and gradually transferred to a bath containing H₂SO₄ (95%) and ice cubes in 20 min, whilst the suspension was stirred. Then, the suspension was filtered and the filtrate was added to an HNO₃ (70%) bath and stirred for 20 min at 40° C. The filtrate was vacuum filtered, washed and dried. The XRD pattern of the final product obtained is shown in FIG. 15c. As seen the product is Si. The Raman spectra of the beach sand and the silicon produced are shown in FIG. 17. The band with a maximum of about 518 cm⁻¹ is characteristic for crystalline silicon.

### EXAMPLE 5

12.00 g tantalum pentoxide (Ta₂O₅, particle sizes 5-10 μm), 2.25 g Mg chips (Sigma Aldrich 254118, 4-30 mesh) and 0.71 g KClO₄ powder (Sigma Aldrich 241830) were mixed and the mixture was loaded into an alumina crucible with a diameter of about 3 cm and height of about 8 cm. The crucible was filled with NaCl. Then the alumina crucible was covered by an alumina lid and loaded into a larger alumina crucible of 6 cm in diameter and 11 cm in height. The empty space inside the crucible was filled with NaCl, and the alumina crucible was closed by an alumina lid. The crucible was then loaded into an electric furnace, and heated to 620° C. with a heating rate of 6° C. min⁻¹. The furnace was immediately turned off at the maximum with no dwell time. At the room temperature, the content of the alumina crucible was washed in distilled water and vacuum filtered. The filtrate was dried at 50° C. under a vacuum of 10⁻⁴ mbar. The x-ray diffraction pattern of the product is seen in FIG. 18. This Figure shows that the product contains a high content of metallic Ta (more than 50 weight percent). Apart from Ta, other components in the product are MgO, Ta₂O₅ and Mg₄Ta₂O₉ which could be removed by an appropriate acid treatment to obtain pure Ta. FIG. 19 shows a SEM image of the product demonstrating that the material contains particles of less than 500 nm.

The processing conditions described in Examples 1-5 (a low processing temperature of 350-580 deg C. and no, or practically no, dwell time) provide an opportunity for large-scale production of metals using metal oxides. No vacuum condition, autoclave, or prolonged treatment is required, although in some embodiments a vacuum can be preferred. FIG. 20 shows a preferred aperture for the process, in which (1) is a metallic or ceramic retort, (2) is a metallic or ceramic container, (3) is a ceramic crucible, (4) is a ceramic bung, (5) is a ceramic or metallic weight, (6) is the reacting mixture, (7) is a salt powder (for example NaCl), (8) is a tube connected to a vacuum pump, and (9) is a pressure relief valve. In the preferred aperture shown in FIG. 20, the reacting mixture (6), comprising one or more single or mixed oxides of metal and/or semi-metal other than titanium and a strong oxidising agent or a metal halide, is compacted into the ceramic crucible (3) which can be Al₂O₃. The crucible is placed into the steel container (2) and the empathy space above the reacting mixture and the gap between the alumina crucible (3) and the steel container (2) is filled with a salt. The salt is preferred to be inexpensive, highly soluble in water, and inert to the reacting materials and products. The preferred salt can be NaCl. A ceramic bung (4) is then placed on the ceramic crucible (3) and the system is placed into the steel retort (1). Then a metallic weight (5) is placed on the ceramic bung. The steel reactor is equipped with a steel flanged cap having a tube (8) connected to a vacuum pump, and a pressure relied valve (9). It is preferred that a vacuum of more than about 10⁻¹ mbar or more than about 10⁻² mbar is established inside the steel retort (1), before heating. The vacuum can further prevent the reducing agent in the reacting mixture from oxidation. The other advantage of having a vacuum inside the steel retort explains as follows: During heating, the reaction between the reacting mixture components occurs in a very short time, releasing heat. The heat generated can increase the kinetic energy of the gas molecules inside the reactor in a very short time increasing the pressure inside the steel retort. By providing a vacuum inside the steel retort, the amount of gas inside the retort sharply decreases and therefore the pressure increase will be negligible. The presence of a pressure relief valve (9) is preferred especially when the pressure inside the steel retort, before the reaction, is near to the atmospheric pressure. For example, when the steel retort is filled with an inert gas instead of vacuum, particularly at larger production scales (for example greater than 100 Kg of the reacting mixture). The presence of vacuum between the retort (1) and the ceramic container (2) (in FIG. 20) is also preferred because vacuum is an excellent heat insulator, which prevents the retort (2) from being hot during the process at larger scale production (For example larger than 10 Kg of the reacting mixture). As an alternative to the vacuum, the gap between (1) and (2) in FIG. 20 can be fully filled with an inert powder such as NaCl or Al₂O₃, in order to remove gas from the retort (1). Alkali metal inorganic salts, such as NaCl, are preferred as the filler material since they can easily be washed off from the products.

Some preferred embodiments of the present invention:
1. A process for the production of Mg₂Si and MgO by the reaction between SiO₂, Mg and KClO₄ with a reaction temperature of less than 580° C. with no dwelling time at the reaction temperature.
2. A process for the production of Si and MgO by the reaction between SiO₂, Mg and KClO₄ with a reaction temperature of less than 580° C. with no dwelling time at the reaction temperature.
3. A process for the production of Si by the reaction between acids and Mg₂Si.
4. The same method can be used for the de-oxidation of other oxides like GeO₂, Ta₂O₅, Nb₂O₅, WO₂, MoO₂, ZrO₂ and HfO₂; and their mixtures.
5. A product which comprises Mg₂Si+Si+MgO

### REFERENCES

[1] Mineral Commodity Summery 215, USGS, 2014.
[2] M. Nagamori, I. Malinsky, A. Claveau, Thermodynamics of the silicon-carbonoxygen system for the production of silicon carbide and metallic silicon, Metall. Trans. B, 1986, 17, 503-514.
[3] N. Yoshikawa, A. Kikuchi, S. Taniguchi, Anomalous Temperature Dependence of the Growth Rate of the Reaction Layer between Silica and Molten Aluminum, J. Am. Ceram. Soc., 2002, 85, 1827-34.
[4] W. Deqing, S. Ziyun, Aluminothermic reduction of silica for the synthesis of alumina-aluminium-silicon composites, J. Mater. Synth. Process., 2001, 9, 241-246.
[5] T. Nohira, K. Yasuda, Y. Ito, Pinpoint and bulk electrochemical reduction of insulating silicon dioxide to silicon, Nature mater., 2003 2, 397-403.
[6] C. X. Jin, P. Gao, D. Wang, X. Hu, G. Z. Chen, Electrochemical Preparation of Silicon and Its Alloys from Solid Oxides in Molten Calcium, Angew. Chem. Int. Ed. 2004, 43, 733-736.
[7] Y. Zhang, Y. Jiang, Y. Li, B. Li, Z. Li, C. Niu, Preparation of nanographite sheets supported Si nanoparticles by in situ reduction of fumed SiO₂ with magnesium for lithium ion battery, J. Power Sources, 2015, 281,425-431.
[8]K. H. Kim, D. J. Lee, K. M. Cho, S. J. Kim, J. K. Park, H. T. Jun, Complete magnesiothermic reduction reaction of vertically aligned mesoporous silica channels to form pure silicon nanoparticles, SCI. REP., 2015, 5, 9014.
[9] S. Zhu, C. Zhu, J. Ma, Q. Meng, Z. Guo, Z. Yu, T. Lu, Y. Li, D. Zhang, W. M. Lau, Controlled fabrication of Si nanoparticles on graphene sheets for Li-ion batteries, RSC Adv., 2013, 3, 6141-6146.
[10] Z. Bao, M. R. Weatherspoon, S. Shian, Y. Cai, P. D. Graham et al. Chemical reduction of three-dimensional silica micro-assemblies into microporous silicon replicas, Nature, 2007, 446, 172-175.
[11] D. Qiu, G. Bu, B. Zhao, Z. Lin, Mesoporous silicon microspheres fabricated via in situ magnesiothermic reduction of silicon oxide as a high-performance anode material for lithium-ion batteries, J. Solid State Electrochem., 2015, 19, 935-939.
[12] Q. Li, L. Yin, X. Gao, Reduction chemical reaction synthesized scalable 3D porous silicon/carbon hybrid architectures as anode materials for lithium ion batteries with enhanced electrochemical performance, RSC Adv., 2015,5,35598-35607.
[13] H. Zhong, H. Zhan, Y. H. Zhou, Synthesis of nanosized mesoporous silicon by magnesium-thermal method used as anode material for lithium ion battery, J. of Power Sources, 2014, 262,10-14.
14] B. Sun, S. Li, H. Imai, J. Umeda, K. Kondoh, Synthesis kinetics of Mg₂Si and solid-state formation of Mg—Mg₂Si composite, Powder Technol., 2012, 217,157-162.
[15] C. Xiao, N. Du, H. Zhang, D. Yang, Improved cyclic stability of Mg₂Si by direct carbon coating as anode materials for lithium-ion batteries, J. Alloys Comp., 2014, 587, 807-811.
[16] Y. Liu, Y. He, R. Ma, M. Gao, H. Pan, Improved lithium storage properties of Mg₂Si anode material synthesized by hydrogen-driven chemical reaction, Electrochem. Commun., 2012, 25, 15-18.
[17] X. Hu, D. Mayson, M. R. Barnett, Synthesis of Mg₂Si for thermoelectric applications using magnesium alloy and spark plasma sintering, J. Alloys Comp., 2014, 589, 485-490.
[18] A. L. Chaudhary, D. A. Sheppard, M. Paskevicius, C. J. Webb, E. MacA. Gray, C. E. Buckley, Mg₂Si Nanoparticle Synthesis for High Pressure Hydrogenation, J. Phys. Chem. C, 2014, 118, 1240-1247.
[19] A. Xing, J. Zhang, Z. Bao, Y. Mei, A. S. Gordin, K. H. Sandhage, A magnesiothermic reaction process for the scalable production of mesoporous silicon for rechargeable lithium batteries, Chem. Commun., 2013,49, 6743.
[20] N. Lin, Y. Han, J. Zhou, K. Zhang, T. Xu, Y. Zhu, Y. Qian, A Low Temperature Molten Salt Process for Aluminothermic reduction of Silicon Oxides to Crystalline Si for Li-ion Batteries, Energy Environ. Sci., 2015, 8, 3187-3191.
[21] J. Tani, M. Takahashi, H. Kido, Thermoelectric properties and oxidation behaviour of Magnesium Silicide, IOP Conf. Series: Mater. Sci. Eng., 2011, 18, 142013.
[22] J. Liang, X. Li, Z. Hou, C. Guo, Y. Zhu, Y. Qian, Nanoporous silicon prepared through air-oxidation demagnesiation of Mg₂Si and properties of its lithium ion batteries, Chem. Commun., 2015,51, 7230-7233.
[23] E. G. Rochow, The Chemistry of Silicon, Pergamon Press, 1975, pp 1357.
[24] A. A. Ischenko, G. V. Fetisov, L. A. Aslanov, Nanosilicon, properties, synthesis, applications, methos of analysis and control, CRC Press, Taylor & Francis Group, 2015, PP. 162.
[25] K. S. W Sing, D. H. Everett, R. A. W. Haul, L. Moscou, R. A. Pierotti, J. Rouquerol, T. Siemieniewska, Reporting physisorption data for gas/solid systems with special reference to the determination of surface area and porosity. Pure Appl. Chem., 1985; 57,603-19.
[26] E. P. Barrett, L. G. Joyner, P. P. Halenda. The determination of pore volume and area distributions in porous substances I. Computations from nitrogen isotherms. J. Am. Chem. Soc., 1951, 73,373-80.

1. A method of reducing one or more single or mixed oxides of metal and/or semimetal other than titanium, which involves use of an initial reaction at a temperature of less than 580° C. between a strong oxidising agent with a reducing agent to effect reduction of said oxide(s); wherein the oxide(s) to be reduced comprises one or more of the following, namely: oxide of silicon, tantalum, niobium, tungsten, molybdenum, germanium, hafnium or zirconium; wherein the initial reaction proceeds at a temperature in the range of 350° C. to less than 580° C., with no mandatory dwell time.

2. The method as claimed in claim 1, wherein the said oxide(s) to be reduced is admixed with said oxidising and reducing agents.

3. The method of reducing as claimed in claim 2, wherein the oxide(s) of metal and/or semi metal catalyse the reaction between the oxidising agent and reducing agent.

4. The method of reducing as claimed in claim 1 wherein the oxide particle size ranges from micrometers to nanometers.

5. The method as claimed in claim 1, in which the initial reaction proceeds at a temperature in the range of 360° C. to 550° C.

6. The method as claimed in claim 1, in which the initial reaction proceeds preferably at a temperature in the range of 370° C. to 530° C.

7. The method as claimed in claim 1, wherein the reduction reaction process produces the elemental metal and/or semi-metal and/or reaction product comprising the said elemental metal or semi-metal and the said reducing agent.

8. The method as claimed in claim 6 wherein said reaction product forms and is subsequently converted to the said elemental metal and/or semi-metal.

9. The method as claimed in claim 7 in which the said conversion is effected subsequently by acid washing or by treatment with an ammonium agent.

10. The method as claimed in claim 1, wherein the oxide comprises or consists of silica.

11. The method as claimed in claim 1, wherein the oxide has a particle size of 100 to 600 microns, or mainly consists of particles less than 100 microns in size.

12. The method as claimed in claim 1, wherein the reduction reaction is effected within a vacuum or an inert gaseous atmosphere.

13. The method as claimed in claim 12, in which the atmosphere is of Argon or Nitrogen.

14. The method as claimed in claim 1, wherein the oxidising agent comprises one or more of: perchlorate, chlorate, chromate, oxalate, chlorite, dinitramide or the metal halide comprises iron trichloride.

15. The method as claimed in claim 14 in which the oxidising agent consists of perchlorate.

16. The method as claimed in claim 1, wherein the reducing agent comprises or consists of a metal more reactive in the electrochemical series than the metal and/or semi-metal(s) of the oxide(s) being reduced.

17. The method as claimed in claim 16 in which the metal reducing agent is selected from an alkali metal or alkaline earth metal or aluminium.

18. The method as claimed in claim 17 in which the reducing metal is one or more of Mg, Ca, or Al but preferably Mg, which may be in the form of chips with a mesh size of 4 to 30 mesh.

19. The method as claimed in claim 1, in which the oxide is silica, which has optionally been ball-milled, and preferably includes nano-particles.

20. The method as claimed in claim 1, in which the dwell time is in the range of 0 to 30 minutes.

21. The method as claimed in claim 1, in which the oxide to be reduced is silica and the obtained silicon is in powder form with agglomerates of fine particles, which are less than 100 microns in size, and containing portions of nano-sheets.

22. The method as claimed in claim 1, in which the core of particles of the oxide(s) is reduced together with the surface of the particles.

23. The method as claimed in claim 1, wherein the reduction reaction process carried out in the presence of an inert salt as a reaction dampener. wherein the inert salt is sodium chloride followed by its removal from the reaction product(s).

24. An apparatus for carrying into effect a method as claimed in claim 1, which apparatus is substantially as described and/or as illustrated and/or as exemplified herein.

25. The apparatus as claimed in claim 24 comprising a filling and/or covering above the reaction mixture of an inert salt as a reaction dampener, wherein the inert salt is sodium chloride.

26. A method of converting a metallic and/or semi-metallic silicide to elemental silicon which comprises acid washing of the silicide.

27. The method as claimed in claim 26 wherein the metallic silicide is Mg₂Si.

28. A reaction product obtained from a method as claimed in claim 1 which comprises Mg₂Si and MgO.

29. (canceled)

30. (canceled)
